(19) United States
(12) Patent Application Publication
(10) Pub. No.: US 2025/0192172 A1
(43) Pub. Date: Jun. 12, 2025

(54) Cathode for Lithium Secondary Battery and Lithium Secondary Battery Including the Same

(71) Applicants: SK ON Co., Ltd., Seoul (KR); SK Innovation Co., Ltd., Seoul (KR)

(72) Inventors: Young Uk PARK, Daejeon (KR); Seung Hyun KIM, Daejeon (KR); Soon Bo LEE, Daejeon (KR); Min Suk KANG, Daejeon (KR); Hyun Sung KANG, Daejeon (KR); Ji Yae DO, Daejeon (KR); Min Cheol BEAK, Daejeon (KR); Ju Wook LEE, Daejeon (KR); Jeong Hoon JEUN, Daejeon (KR)

(21) Appl. No.: 18/968,072

(22) Filed: Dec. 4, 2024

(30) Foreign Application Priority Data
Dec. 8, 2023 (KR) 10-2023-0177737

(51) Int. Cl. H01M 4/525; H01M 4/02

(52) U.S. Cl. CPC H01M 4/525; H01M 2004/021

(57) ABSTRACT

A cathode for a lithium secondary battery includes lithium metal oxide particles having CM defined by D*(E_{IT}/H_{IT})/[(Li/Me)²] of of 70 or more. D is an average particle diameter value calculated in micrometers after measuring diameters of particles with a diameter of 4 μm or more in the lithium metal oxide particles included in a scanning electron microscope (SEM) image showing a thickness*width cross-section of the cathode active material layer. E_{IT} is a modulus value of the lithium metal oxide particles measured by a nano indentation method. H_{IT} is a hardness value of the lithium metal oxide particles measured by a nano indentation method. Li/Me is a molar ratio of lithium to metals other than lithium in the lithium metal oxide particles.

### CROSS-REFERENCE TO RELATED APPLICATION

This application claims priority to Korean Patent Application No. 10-2023-0177737 filed Dec. 8, 2023, the disclosure of which is hereby incorporated by reference in its entirety.

### BACKGROUND

### Technical Field

The disclosure relates to a cathode for a lithium secondary battery and a lithium secondary battery including the same.

### Technical Considerations

A secondary battery which can be charged and discharged repeatedly has been widely employed as a power source of a mobile electronic device such as a camcorder, a mobile phone, a laptop computer, etc. Recently, a battery pack including the secondary battery is being developed and applied as a power source of an eco-friendly vehicle such as a hybrid automobile, an electric automobile.

Examples of the secondary battery include a lithium secondary battery, a nickel-cadmium battery, a nickel-hydrogen battery, etc. The lithium secondary battery is being actively developed and applied due to high operational voltage and energy density per unit weight, a high charging rate, a compact dimension, etc.

For example, the lithium secondary battery may include an electrode assembly including a cathode, an anode and a separation layer (separator), and an electrolyte immersing the electrode assembly. The lithium secondary battery may further include an outer case having, e.g., a pouch shape accommodating the electrode assembly and the electrolyte.

A lithium metal oxide may be used as a cathode active material of a lithium secondary battery. As an application range of the lithium secondary battery has been expanded, a lithium secondary battery having extended life-span, higher capacity and higher energy density is being developed. For example, silicon and carbon can be used together for an anode active material to increase the capacity. As a size of the lithium metal oxide increases, the cathode active material may have a higher energy density, but a capacity and a power may be decreased.

### SUMMARY

According to a non-limiting aspect of the present disclosure, there is provided a cathode for a lithium secondary battery having improved structural stability and high temperature storage properties.

According to a non-limiting aspect of the present disclosure, there is provided a lithium secondary battery having improved structural stability and high temperature storage properties.

In non-limiting embodiments or aspects, provided is a cathode for a lithium secondary battery including a cathode current collector and a cathode active material layer on the cathode current collector. The cathode active material layer includes lithium metal oxide particles that have CM defined by Equation 1 of 70 or more as a cathode active material.

$$CM = D * ( {E}_{IT} / {H}_{IT} ) / [ {( Li / Me )}_{2} ] \qquad [ Equation 1 ]$$

In Equation 1, D is an average particle diameter value calculated in micrometers after measuring diameters of particles with a diameter of 4 μm or more in the lithium metal oxide particles included in a scanning electron microscope (SEM) image showing a thickness*width cross-section of the cathode active material layer. E_{IT} is a modulus value of the lithium metal oxide particles measured by a nano indentation method. H_{IT} is a hardness value of the lithium metal oxide particles measured by a nano indentation method. Li/Me is a molar ratio of lithium to metals excluding lithium in the lithium metal oxide particles.

In some non-limiting embodiments, CM may be in a range from 70 to 200.

In some non-limiting embodiments, E_{IT}/H_{IT} in Equation 1 may be 15 or more.

In some non-limiting embodiments, E_{IT}/H_{IT} in Equation 1 may be in a range from 15 to 50.

In some non-limiting embodiments, Li/Me in Equation 1 may be 1.1 or more.

In some non-limiting embodiments, Li/Me in Equation may be in a range from 1.1 to 1.6.

In some non-limiting embodiments, the lithium metal oxide particles may include at least one of nickel and manganese, and a molar ratio of cobalt among metals excluding lithium in the lithium metal oxide particles may be in a range from 0 to 0.1.

In some non-limiting embodiments, the lithium metal oxide particles may include at least one of nickel and manganese, and a molar ratio of manganese among metals excluding lithium in the lithium metal oxide particles may be in a range from 0.4 to 0.75.

In some non-limiting embodiments, the lithium metal oxide particles may have a bi-modal distribution including large-diameter particles and small-diameter particles.

In some non-limiting embodiments, an average particle diameter of the large-diameter particles may be in a range from 7 μm to 20 μm, and an average particle diameter of the small-diameter particles may be in a range from 1 μm to 6 μm.

In some non-limiting embodiments, E_{IT} and H_{IT} in Equation 1 may represent a modulus and a hardness of the large-diameter particles, respectively.

In some non-limiting embodiments, E_{IT} in Equation 1 may be in a range from 20 GPa to 100 GPa.

In some non-limiting embodiments, H_{IT} in Equation 1 may be in a range from 1.0 GPa to 5 GPa.

In some non-limiting embodiments, an electrode density of the cathode active material layer may be 2.8 g/cc or more.

In non-limiting embodiments or aspects, provided is a lithium secondary battery including the above-described cathode for a lithium secondary battery and an anode facing the cathode.

In non-limiting embodiments or aspects, provided is an anode active material for a lithium secondary battery including lithium metal oxide particles having a reduced cobalt content. An average particle diameter, a modulus and a hardness of the lithium metal oxide particles may be adjusted to satisfy a specific equation. Structural stability and high-temperature storage properties of the cathode active material may be improved.

The lithium metal oxide particles may contain cobalt in a small amount of a total transition metal or may not contain cobalt. Thus, a high-quality cathode active material may be provided at a low cost. Additionally, an operating voltage of the lithium secondary battery may be increased using a lithium-rich composition, and a high-Ni composition may be easily introduced so that high-capacity properties may be implemented.

As the average particle diameter, the modulus and the hardness of the lithium metal oxide particles satisfy the specific equation, crack resistance, long-term stability and capacity retention properties may be improved even though the content or a concentration of cobalt is low. The cathode active material having high capacity, high energy density and improved stability may be provided.

### BRIEF DESCRIPTION OF THE DRAWINGS

FIG. 1 is a schematic plan view illustrating a lithium secondary battery in accordance with the principles of the present disclosure; and

FIG. 2 is a cross-sectional view illustrating a lithium secondary battery in accordance with the principles of the present disclosure.

### DETAILED DESCRIPTION

According to non-limiting embodiments of the present disclosure, a cathode for a lithium secondary battery having a lithium metal oxide particle as a cathode active material is provided. According to non-limiting embodiments of the present disclosure, a lithium secondary battery including the cathode is provided.

The cathode active material and the lithium secondary battery of the present disclosure may be widely applied in green technology fields such as an electric vehicle, a battery charging station, a solar power generation, a wind power generation, etc., using a battery, etc. The cathode active material and the lithium secondary battery according to the present disclosure may be used for eco-friendly electric vehicles and hybrid vehicles to prevent a climate change by suppressing air pollution and greenhouse gas emissions. etc.

Hereinafter, the present disclosure will be described in detail with reference to example embodiments. However, these are merely illustrative and the present disclosure is not limited to the specific embodiments provided herein.

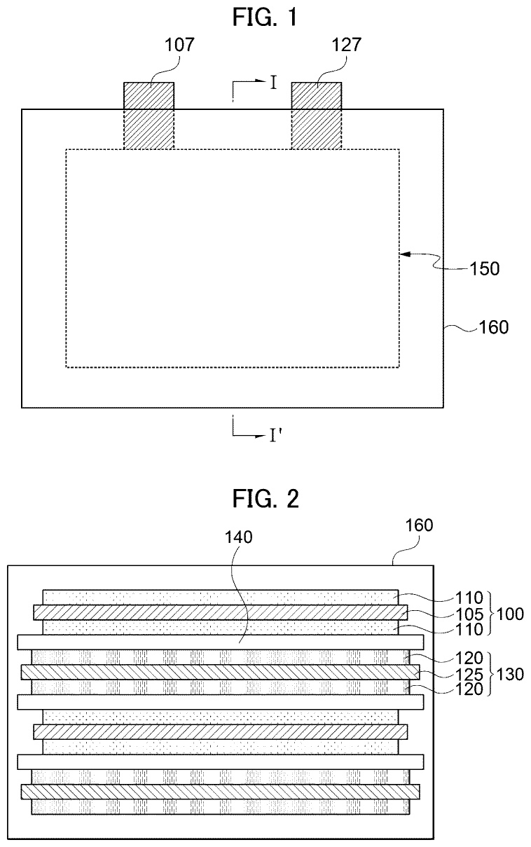

A cathode 100 for a lithium secondary battery according to non-limiting embodiments of the present disclosure may include a cathode current collector 105 and a cathode active material layer 110 formed on at least one surface of the cathode current collector 105 (see FIGS. 1 and 2).

The cathode active material layer 110 may include a plurality of lithium metal oxide particles as a cathode active material. In example embodiments, the lithium metal oxide particle may be present in the form of a lithium-excess oxide particle.

In example embodiments, the lithium excess oxide particle may contain nickel and manganese, and a molar ratio of lithium to the total number of moles of metal elements included in in the lithium excess oxide particle (a ratio of the number of moles of lithium to the total number of moles of metal elements). In some non-limiting embodiments, the lithium excess oxide particles may have a manganese-rich composition. In non-limiting embodiments, manganese (Mn) among elements other than lithium and oxygen included in the lithium excess oxide particle may be included in the highest content (molar ratio).

The cathode active material may include a plurality of the lithium excess oxide particles. In some non-limiting embodiments, a content of the lithium-excess oxide particle based on a total weight of the cathode active material may be 50 wt % or more, 60 wt % or more, 70 wt % or more, 80 wt % or more, or 90 wt % or more.

In non-limiting embodiments, the cathode active material may substantially consist of the lithium-excess oxide particles.

In non-limiting embodiments, the lithium-excess oxide particle may include a Li₂MnO₃ domain (C2/m space group) and a LiₐM_{b}O_{c} domain (R3m space group, M is at least one of Co, Na, Ca, Y, Hf, Ta, B, Si, Ba, Ra, Mg, V, Ti, Al, Fe, Ru, Zr, W, Sn, Nb, Mo, Cu, Zn, Cr, Ga, V and Bi, and 1.8≤a+b≤2.2, 0.9≤a/b<1.05, and 1.9≤c≤2.1). For example, the LiₐM_{b}O_{c} domain may be represented by LiMO₂.

In some non-limiting embodiments, a molar ratio of the Li₂MnO₃ domain and the LiₐM_{b}O_{c} domain (e.g., a LiMO₂ domain) in the lithium-excess oxide particle may be expressed as w:(1-w), and w may be in a range from 0.05 to 0.7, or from 0.1 to 0.7.

For example, the lithium-excess oxide particle may be prepared by a coprecipitation method.

For example, metal salts, a chelating agent (e.g., ammonia water, ammonium carbonate, etc.), and a coprecipitating agent (e.g., sodium hydroxide, sodium carbonate, etc.) may be mixed and subjected to a coprecipitation reaction to prepare an active material precursor (e.g., a metal hydroxide particle). For example, the molar ratio between the metal salts may be controlled according to a target chemical formula of the lithium-excess oxide particle.

The active material precursor may include a manganese hydroxide, or a nickel-manganese hydroxide. The manganese hydroxide or the nickel-manganese hydroxide may contain a small amount of cobalt or may not contain cobalt.

For example, the active material precursor and a lithium source may be mixed and calcined so that a molar ratio of the lithium source to the molar number of the active material precursor may be in a range from 1.05 to 1.95, from 1.1 to 1.95, from 1.15 to 1.95, or from 1.2 to 1.95 to prepare the lithium-excess oxide particle.

In non-limiting embodiments, the lithium source may include lithium hydroxide or lithium carbonate. In some non-limiting embodiments, the lithium source may include lithium hydroxide. In non-limiting embodiments, lithium carbonate may not be used as the lithium source. Accordingly, a particle strength degradation due to a gas generation in the calcination process for forming the active material particle may be prevented.

In example embodiments, the active material precursor and/or the lithium source may each be subjected to a calcination treatment before mixing.

In some non-limiting embodiments, the active material precursor may be subjected to the calcination treatment at a temperature in a range from 300° C. to 700° C. before being mixed with the lithium source. The active material precursor having a hydroxide structure may be at least partially converted into an oxide form having a reduced volume by the calcination treatment. Accordingly, an internal structure (e.g., a secondary particle structure) of the active material precursor may become denser, and mechanical strength may be increased.

Thus, the lithium-excess oxide particle may also have improved strength and hardness properties, and cracks of the active material particles may be suppressed during a press process for forming a cathode active material layer, and high-temperature stability may be improved.

In non-limiting embodiments, the temperature of the calcination treatment may be in a range from 400° C. to 700° C., from 500° C. to 700° C., from 550° C. to 700° C., or from 600° C. to 700° C.

In non-limiting embodiments, the lithium source may also be subjected to the calcination treatment before being mixed with the active material precursor.

A precursor mixture in which the active material precursor and the lithium source are mixed may be fired (heat-treated) to form the lithium-excess oxide particle. A temperature of the firing may be in a range from 600° C. to 1,000° C.

In some non-limiting embodiments, the firing may include a first heat-treatment performed at a relatively high temperature and a second heat-treatment performed at a relatively low temperature. In some non-limiting embodiments, the second heat-treatment may be performed at a temperature of 600° C. or higher, and less than 800° C. The first heat-treatment may be performed at a temperature in a range from 800° C. to 1,000° C.

As described above, the first heat-treatment may be performed at a relatively high temperature to stabilize an element distribution in the particle. Thereafter, the second heat-treatment may be performed at a low temperature to stabilize the strength and hardness properties of the active material particle.

In non-limiting embodiments, lithium impurities or unreacted precursors may be removed through a washing process before the calcination. In non-limiting embodiments, the washing process may be omitted.

In non-limiting embodiments, a modulus (E_{IT}), a hardness (H_{IT}), etc., of the lithium metal oxide particle may be controlled by controlling the co-precipitation reaction time, a reaction temperature, the heat-treatment temperature, washing conditions, etc.

For example, the lithium-excess oxide particle may be activated by applying a voltage of 4.4 V (vs Li/Li+) or higher (e.g., 4.4 V to 4.8 V) to the lithium-excess oxide particles (see Reaction Scheme 1-1 below). Alternatively, a lithium secondary battery including the lithium-excess oxide particle may be charged and discharged at a voltage of 4.4 V (vs Li/Li+) or higher to activate the lithium-excess oxide particle (see Reaction Schemes 1-1 and 1-2 below).

In non-limiting embodiments, the activated particle may include a domain derived from Li₂MnO₃ domain in the lithium-excess oxide particle.

In some non-limiting embodiments, the domain derived from the Li₂MnO₃ domain may include at least one of MnO₂, Mn₂O₄, LiMnO₂, LiMn₂O₄ and Li₂Mn₂O₄.

For example, at least a portion of the Li₂MnO₃ in the lithium-excess oxide particle may be converted into MnO₂ and LiMnO₂ by the activation as shown in Reaction Scheme 1-1 and Reaction Scheme 1-2 below. MnO₂ and LiMnO₂ may reversibly insert and desorb lithium ions as shown in Reaction Scheme 2 below. Accordingly, the lithium-excess oxide particle may provide an increased capacity.

(Charging) Li₂MnO₃→MnO₂+2Li⁺+½O₂+2e⁻ [Reaction Scheme 1-1]

(Discharging) MnO₂+Li⁺+e⁻→LiMnO₂ [Reaction Scheme 1-2]

(Charging) LiMnO₂→MnO₂+Li⁺+e⁻

(Discharging) MnO₂+Li⁺+e⁻→LiMnO₂ [Reaction Scheme 2]

In some non-limiting embodiments, LiMnO₂ in the activated particle may be further reacted to be converted into Mn₂O₄, LiMn₂O₄ or Li₂Mn₂O₄.

In some non-limiting embodiments, the activated particle may include the LiₐM_{b}O_{c} domain, and the Li₂MnO₃ domain and/or the domain derived from the Li₂MnO₃ domain. In example embodiments, the lithium-excess oxide particle and/or the activated particle may be represented by Chemical Formula 1 below.

Liₐ[CoₓNi_{y}Mn_{z}]O_{b} [Chemical formula 1]

In Chemical formula 1, 0≤x≤0.9, 0<y≤0.9, 0.1≤z≤0.9, 1.8≤a+x+y+z≤2.2, 1.05≤a/(x+y+z)≤1.95, and 1.8≤b≤2.2.

In some non-limiting embodiments, 0<x≤0.9, 0.05≤x≤0.9, 0.1≤x≤0.9, 0<x≤0.8, 0.05≤x≤0.8, or 0.1≤x≤0.8.

In some non-limiting embodiments, 0<y≤0.9, 0.05≤y≤0.9, 0.1≤y≤0.9, 0<y≤0.8, 0.05≤y≤0.8, or 0.1≤y≤0.8.

In some non-limiting embodiments, 1.1≤a/(x+y+z)≤1.95, 1.15≤a/(x+y+z)≤1.95, 1.2≤a/(x+y+z)≤1.95, 1.3≤a/(x+y+z)≤1.95, or 1.4≤a/(x+y+z)≤1.95.

a/(x+y+z) may represent a molar ratio of lithium relative to metals other than lithium included in the lithium-excess oxide particle (Li/Me). Li/Me may be greater than or equal to 1.1 (e.g., from 1.1 to 1.95, from 1.1 to 1.9, from 1.1 to 1.8, from 1.1 to 1.7, from 1.1 to 1.6, from 1.1 to 1.5, or from 1.1 to 1.4)

In some non-limiting embodiments, Li/Me may be 1.15 or more (e.g., from 1.15 to 1.95, from 1.15 to 1.9, from 1.15 to 1.8, from 1.15 to 1.7, from 1.15 to 1.6, or from 1.15 to 1.5, or from 1.15 to 1.4), 1.2 or more (e.g., from 1.2 to 1.95, from 1.2 to 1.9, from 1.2 to 1.8, from 1.2 to 1.7, from 1.2 to 1.6, or from 1.2 to 1.5, or from 1.2 to 1.4), 1.3 or more (e.g., from 1.3 to 1.95, from 1.3 to 1.9, from 1.3 to 1.8, from 1.3 to 1.7, from 1.3 to 1.6, from 1.3 to 1.5, or from 1.3 to 1.4).

In non-limiting embodiments, Li/Me may be in a range from from 1.1 to 1.6, from 1.1 to 1.5, from 1.1 to 1.4, from 1.15 to 1.6, from 1.15 to 1.5, from 1.15 to 1.4, from 1.2 to 1.6, from 1.2 to 1.5, from 1.2 to 1.4, from 1.25 to 1.6, from 1.25 to 1.5, or from 1.25 to 1.4.

In some non-limiting embodiments, a molar ratio of manganese relative to total elements excluding lithium and oxygen in the lithium-excess oxide particles may be in a range from from 0.4 to 0.75. For example, 0.4≤z/(x+y+z)≤0.75. In some non-limiting embodiments, 0.4≤z/(x+y+z)≤0.7, 0.4≤z/(x+y+z)≤0.6 0.5≤z/(x+y+z)≤0.7, or 0.5≤z/(x+y+z)≤0.6.

In some non-limiting embodiments, a mole fraction of cobalt (x in Chemical Formula 1) relative to all elements excluding lithium and oxygen in the lithium-excess oxide particle may be in a range from 0 to 0.1. In non-limiting embodiments, the mole fraction of cobalt may be in a range from 0 to 0.05, from 0 to 0.04, from 0 to 0.03, from 0 to 0.02, or from 0 to 0.01. In non-limiting embodiments, the lithium-excess oxide particle may not contain cobalt.

Accordingly, a production cost of the cathode active material may be reduced, and a uniform and high-quality cathode may be manufactured. For example, cobalt requires high cost due to a small supply. Further, when an amount of cobalt increases, a high-quality cathode active material may not be uniformly and easily obtained.

According to non-limiting embodiments of the present disclosure, the content of cobalt may be reduced, so that the contents of manganese or nickel may be relatively increased, and chemical stability and energy density/power properties of the cathode active material may also be increased. The term “content” or “concentration” used herein may refer to a molar ratio or a molar concentration in lithium metal oxide particle.

The chemical structure represented by Chemical Formula 1 represents a bonding relationship included in a layered structure or a crystal structure of the cathode active material, and does not exclude other additional elements. For example, Ni, Mn and Co may serve as a main active element of the cathode active material. Chemical Formula 1 is provided to express the bonding relationship of the main active element and is to be understood as a formula encompassing introduction and substitution of the additional elements.

In non-limiting embodiments, an auxiliary element for enhancing chemical stability of the cathode active material or the layered structure/crystal structure in addition to the main active element may be further included. The auxiliary element may be incorporated into the layered structure/crystal structure to form a bond, and this case is to be understood as being included within the range of the chemical structure represented by Chemical Formula 1.

The auxiliary element may include at least one of, e.g., Na, Mg, Ca, Hf, V, Nb, Ta, Cr, Mo, Fe, Cu, Ag, Zn, Ga, C, Si, Sn, Ra, P and S. The auxiliary element may act as an auxiliary active element that contributes to capacity/power activity of the cathode active material together with Ni or Mn.

In some non-limiting embodiments, the cathode active material or the lithium metal oxide particle (the lithium-excess oxide particle) may have a shape of a secondary particle. The secondary particle may refer to a structure in which a plurality of primary particles are aggregated to form a single particle. For example, one secondary particle may include 10 or more, 20 or more, 30 or more, 40 or more, 50 or more, 60 or more, or 100 or more primary particles.

For example, in a scanning electron microscope (SEM) cross-sectional image of the cathode active material layer, a form in which a plurality of primary particles are aggregated within a boundary of one of the secondary particles may be observed.

In some non-limiting embodiments, the cathode active material or the lithium metal oxide particle (the lithium-excess oxide particle) may have a bimodal particle size distribution. The term “bimodal” used herein may refer to a distribution in which peaks are distinctly shown at two average particle diameters in a graph representing a particle size distribution.

In a graph showing a particle size distribution, a distribution in which a single peak is clearly shown at one average particle size may be referred to as a unimodal form.

For example, the cathode active material or the lithium metal oxide particle (the lithium-excess oxide particles) may include large-diameter particles and small-diameter particles. An average particle size (D50) of the large-diameter particles may be in a range from 7 μm to 20 μm. In non-limiting embodiments, the average particle size (D50) of the large-diameter particles may be in a range from 8 μm to 20 μm, or from 9 μm to 15 μm.

The average particle size (D50) of the small-diameter particles may be 1 μm to 6 μm. In non-limiting embodiments, the average particle size (D50) of the small-diameter particles may be in a range from 2 μm to 6 μm, from 2 μm to 5 μm, or from 2 μm to 4 μm.

The small-diameter particles may be distributed in pores between the large-diameter particles to increase an energy density from the cathode active material layer, and may prevent particle cracks during the press process. Sufficient capacity and power may be obtained from the cathode active material using the large-diameter particles. According to non-limiting embodiments of the present disclosure, the large-diameter particles may have hardness and strength properties as described below, and may further increase overall high-temperature stability and chemical stability in the cathode active material layer.

D50 may be a particle size at a point where a volume accumulation is 50% in a volumetric particle size distribution of the lithium metal oxide particles.

In some non-limiting embodiments, a weight ratio of the large-diameter particles and the small-diameter particles may be controlled in a range from 2:8 to 8:2, from 3:7 to 7:3, or from 4:6 to 6:4.

In some non-limiting embodiments, the lithium metal oxide particles may have a unimodal particle size distribution. In this case, an average particle size of the lithium metal oxide particles may be in a range from 4 μm to 10 μm, from 4 μm to 8 μm, or from 5 μm to 8 μm.

According to non-limiting embodiments of the present disclosure, a chemical-mechanical property parameter (hereinafter, referred to as CM) defined by Equation 1 measured from the cathode active material may be 70 or more. In the above range, mechanical properties of the lithium metal oxide particles may be increased, and sufficient high-temperature stability and electrical properties may be achieved even in the above-described Co-less and lithium-excess composition.

$$[ Equation 1 ]$$

$$Chemical - mechanical property parameter ( CM ) = D * ( {E}_{IT} / {H}_{IT} ) / [ {( Li / Me )}_{2} ]$$

In Equation 1, D is an average particle size calculated in micrometers after measuring diameters of particles having a diameter of 4 μm or more in the lithium metal oxide particles included in a scanning electron microscope (SEM) image showing a thickness*width cross-section of the cathode active material layer.

The particles having a diameter of less than 4 μm may have low reliability in E_{IT} and H_{IT} measurements, and may be excluded when measuring the particle size. Thus, effectiveness of improving chemical and mechanical properties of the cathode active material layer by a CM control may be enhanced.

E_{IT} may be a modulus value of the lithium metal oxide particles measured by a nano indentation test. H_{IT} may be a hardness value of the lithium metal oxide particles measured by the nano indentation test. E_{IT} and H_{IT} may each be expressed in a unit of GPa. For example, E_{IT} and H_{IT} of the lithium metal oxide particles may be measured under the conditions of a maximum indentation load of 7 mN, an indentation time of 70 seconds, and a creep time of 5 seconds using a nano indentation tester.

In some non-limiting embodiments, E_{IT} and H_{IT} may be values obtained by measuring modulus values and hardness values of 10 or more, 50 or more, 100 or more, and 300 or more of the lithium metal oxide particles and calculating an arithmetic average of the measured values. As the number of measured particles increases, accuracy and reliability of the E_{IT} and H_{IT} values may be improved.

For example, when measuring E_{IT} and H_{IT} in the state of the cathode active material layer, 10 regions, 50 regions, 100 regions, or 300 or more regions of the cross-section of the cathode active material layer may be selected. The lithium metal oxide particles present in the corresponding regions may be obtained, and modulus values and hardness values of each region may be measured. The measured values can be arithmetic averaged to calculate E_{IT} and H_{IT} of Equation 1.

As described above, when the cathode active material has the bi-modal distribution including the large-diameter particles and the small-diameter particles, the parameter value of Equation 1 may be measured for the large-diameter particles.

In some non-limiting embodiments, when the cathode active material has the bi-modal distribution, particles within a range of ±0.5 μm from the average particle diameter of the large-diameter particles may be selected to measure E_{IT} and H_{IT}. Thereafter, an arithmetic average may be calculated to obtain E_{IT} and H_{IT} of Equation 1.

In some non-limiting embodiments, when the cathode active material has the uni-modal distribution, particles within a range of ±0.5 μm from an average particle diameter (D50) of the particles are selected to measure E_{IT} and H_{IT}. Thereafter, an arithmetic average may be calculated to obtain E_{IT} and H_{IT} of Equation 1.

In some non-limiting embodiments, CM of Equation 1 may be in a range from 70 to 200. In the above range, deterioration of electrolyte impregnation properties and increase in resistance due to excessive increase in a density of active material particles may be prevented.

In non-limiting embodiments, CM of Equation 1 may be in a range from 80 to 200, or from 90 to 180.

In some non-limiting embodiments, E_{IT}/H_{IT} of CM of Equation 1 may be 15 or more. In this case, mechanical properties of the large-diameter particles may be sufficiently increased and high-temperature stability may be improved. In non-limiting embodiments, E_{IT}/H_{IT} of the parameter A of Equation 1 may be 20 or more.

In non-limiting embodiments, E_{IT}/H_{IT} may be in a range from 15 to 50, from 15 to 40, from 15 to 30, from 15 to 28, from 15 to 26, from 20 to 50, from 20 to 40, from 20 to 30, from 20 to 28, from 20 to 26.

For example, when the hardness and the particle size of the lithium metal oxide particles become excessively large relative to the modulus, damages may occur in a crystallinity and a structure due to a pressure or a heat applied to the particles. In this case, the crystallinity and the structure of the particles may be transformed during an electrode manufacturing process, an operating environment and charge/discharge processes, and side reactions with an electrolyte may be increased at exposed particle interfaces.

In some non-limiting embodiments, E_{IT} of CM of Equation 1 may be in a range from 20 GPa to 100 GPa, from 30 GPa to 80 GPa, from 30 GPa to 70 GPa, or from 30 GPa to 65 GPa.

In some non-limiting embodiments, H_{IT} of the CM of Equation 1 may be in a range from 1.0 GPa to 5 GPa, from 1.0 GPa to 4 GPa, from 1.5 GPa to 5 GPa, or from 1.5 GPa to 4 GPa.

In the above range, a balance of the modulus and the hardness may be appropriately maintained, and chemical and mechanical stability of the cathode active material may be more easily enhanced.

In example embodiments, the modulus, the hardness, and the size of the lithium metal oxide particles may be adjusted in the above-described range, impact resistance, heat resistance and high-temperature storage properties of the cathode active material may be improved.

Thus, even when the lithium metal oxide particle has a low cobalt content, high-temperature capacity retention and cycle properties may be improved, and an amount of a gas generated by the side reaction may be reduced. Accordingly, a high-quality cathode active material may be obtained at low cost.

FIGS. 1 and 2 are a schematic plan view and a schematic cross-sectional view, respectively, illustrating a lithium secondary battery in accordance with example embodiments. For example, FIG. 2 is a cross-sectional view taken along a line I-I′ of FIG. 1 in a thickness direction.

The structure of the secondary battery illustrated in FIG. 1 and FIG. 2 is provided as a schematic example for convenience of descriptions, and the secondary battery of the present disclosure is not limited to the structure of FIGS. 1 and 2.

Referring to FIGS. 1 and 2, the lithium secondary battery may include a cathode 100 and an anode 130 facing the cathode 100.

The cathode 100 may include a cathode current collector 105 and a cathode active material layer 110 formed on at least one surface of the cathode current collector 105. The cathode active material layer 110 may include a cathode active material including the above-described lithium metal oxide particles.

For example, a cathode slurry may be prepared by mixing and stirring the cathode active material with a binder, a conductive material and/or a dispersive agent in a solvent. The cathode slurry may be coated on at least one surface of the cathode current collector 105, and then dried and pressed to prepare the cathode 100.

For example, the cathode current collector 105 may include stainless steel, nickel, aluminum, titanium, or an alloy thereof. The cathode current collector may include aluminum or stainless steel surface-treated with carbon, nickel, titanium or silver. For example, a thickness of the cathode current collector 105 may be 5 μm to 50 μm.

The binder may include polyvinylidene fluoride (PVDF), vinylidene fluoride-hexafluoropropylene copolymer, polyacrylonitrile, polymethyl methacrylate, acrylonitrile-butadiene rubber (NBR), polybutadiene rubber (BR), styrene-butadiene rubber (SBR), a polyacrylic acid-based binder, poly(3,4-ethylenedioxythiophene) (PEDOT)-based binder, or the like. In some non-limiting embodiments, a PVDF-based binder may be used as the cathode binder.

The conductive material may be used to improve conductivity and/or mobility of lithium ions or electrons. For example, the conductive material may include a carbon-based conductive material such as graphite, carbon black, acetylene black, Ketjen black, graphene, a carbon nanotube, a vapor-grown carbon fiber (VGCF), a carbon fiber, etc., and/or a metal-based conductive material such as tin, tin oxide, titanium oxide, a perovskite material including LaSrCoO₃ and LaSrMnO₃, etc.

In example embodiments, a density (an electrode density or a mixture density) of the cathode active material layer 110 may be 2.8 g/cc or more, and in non-limiting embodiments, may be 3.0 g/cc or more. For example, the density of the cathode active material layer 110 may be in a range from 3.0 g/cc to 4.0 g/cc, or from 3.0 g/cc to 3.5 g/cc.

In the density range, particle cracks may be prevented, and increased mechanical properties of the lithium metal oxide particles may be sufficiently implemented in a unit of the active material layer.

The anode 130 may include an anode current collector 125 and an anode active material layer 120 formed on at least one surface of the anode current collector 125. The anode active material layer 120 may include an anode active material.

Non-limiting examples of the anode current collector 125 may include a copper foil, a nickel foil, a stainless steel foil, a titanium foil, a nickel foam, a copper foam, a polymer substrate coated with a conductive metal, or the like. A thickness of the anode current collector 125 may be, e.g., in a range from 5 μm to 50 μm.

The anode active material may include a material widely used in the related art capable of intercalating and de-intercalating lithium without a particular limitation. For example, a carbon-based material such as a crystalline carbon, an amorphous carbon, a carbon composite and carbon fiber, a lithium metal, a lithium alloy, a silicon-containing material or a tin-containing material may be used.

Examples of the amorphous carbon include hard carbon, soft carbon, coke, a mesocarbon microbead (MCMB), a mesophase pitch-based carbon fiber (MPCF), or the like.

Examples of the crystalline carbon include a graphite-based carbon such as natural graphite, artificial graphite, a graphitized coke, a graphitized MCMB, a graphitized MPCF, or the like.

The lithium metal may include pure lithium metal or a lithium metal having a protective layer formed thereon for suppressing a dendrite growth. In non-limiting embodiments, a lithium metal-containing layer deposited or coated on the anode current collector may be used as the anode active material layer. In non-limiting embodiments, a lithium thin-film may be used as the anode active material layer.

Elements included in the lithium alloy may include aluminum, zinc, bismuth, cadmium, antimony, silicon, lead, tin, gallium, indium, or the like.

The silicon-containing material may provide more increased capacity properties. The silicon-containing material may include Si, SiOx (0<x<2), a metal-doped SiOx (0<x<2), a silicon-carbon composite, or the like. The metal may include lithium and/or magnesium, and the metal-doped SiOx (0<x<2) may include metal silicate.

In some non-limiting embodiments, an anode slurry may be prepared by mixing and stirring the anode active material with a binder, a conductive material and/or a dispersive agent in a solvent. The anode slurry may be coated on at least one surface of the anode current collector, dried and pressed to prepare the anode 130.

Materials substantially the same as or similar to the binder and the conductive material included in the cathode may also be used. In some non-limiting embodiments, a styrene-butadiene rubber (SBR)-based binder, carboxymethyl cellulose (CMC), a polyacrylic acid-based binder, poly(3,4-ethylenedioxythiophene) (PEDOT)-based binder, etc., may be used as the anode binder.

In some non-limiting embodiments, a separator 140 may be interposed between the cathode 100 and the anode 130. For example, the separator 140 may include a porous polymer film or a porous non-woven fabric. The porous polymer film may include a polyolefin-based polymer such as an ethylene polymer, a propylene polymer, an ethylene/butene copolymer, an ethylene/hexene copolymer, an ethylene/methacrylate copolymer, or the like.

The porous non-woven fabric may include a high melting point glass fiber, a polyethylene terephthalate fiber, or the like.

The separator 140 may include a ceramic-based material. For example, inorganic particles may be coated on the polymer film or dispersed in the polymer film to improve a heat resistance.

The separator 140 may have a single-layered or a multi-layered structure including the polymer film and/or the non-woven fabric as described above.

In example embodiments, an electrode cell may be defined by the cathode 100, the anode 130 and the separator 140, and a plurality of the electrode cells may be stacked to form an electrode assembly 150. The electrode assembly 150 may be a winding type, a stack type, a z-folding type, or a stack-folding type.

The electrode assembly 150 may be accommodated within a case 160 together with an electrolyte solution to define a lithium secondary battery. In example embodiments, a non-aqueous electrolyte solution may be used as the electrolyte solution.

The non-aqueous electrolyte solution may include a lithium salt as an electrolyte and an organic solvent. The lithium salt may be represented by Li⁺X⁻, and an anion of the lithium salt X⁻ may include, e.g., F⁻, Cl⁻, Br⁻, I⁻, NO₃⁻, N(CN)₂⁻, BF₄⁻, ClO₄⁻, PF₆⁻, (CF₃)₂PF₄⁻, (CF₃)₃PF₃⁻, (CF₃)₄PF₂⁻, (CF₃)₅PF⁻, (CF₃)₆P⁻, CF₃SO₃⁻, CF₃CF₂SO₃⁻, (CF₃SO₂)₂N⁻, (FSO₂)₂N⁻, CF₃CF₂(CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, CH₃CO₂⁻, SCN⁻, (CF₃CF₂SO₂)₂N⁻, etc.

Examples of the organic solvent include propylene carbonate (PC), ethylene carbonate (EC), diethyl carbonate (DEC), dimethyl carbonate (DMC), ethyl methyl carbonate (EMC), methylpropyl carbonate, dipropyl carbonate, dimethyl sulfoxide, acetonitrile, dimethoxyethane, diethoxyethane, vinylene carbonate, sulfolane, gamma-butyrolactone, propylene sulfite, tetrahydrofuran, or the like. These may be used alone or in combination of two or more therefrom.

In some non-limiting embodiments, a solid electrolyte may be used instead of the non-aqueous electrolyte solution. In this case, the lithium secondary battery may be manufactured in the form of an all-solid-state battery. Additionally, a solid electrolyte layer may be disposed between the cathode and the anode instead of the separator 140.

The solid electrolyte may include a sulfide-based electrolyte. Non-limiting examples of the sulfide-based electrolyte include Li₂S—P₂S₅, Li₂S—P₂S₅—LiCl, Li₂S—P₂S₅—LiBr, Li₂S—P₂S₅—LiCl—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (m and n are positive numbers, and Z represents Ge, Zn or Ga), Li₂S—GeS₂, Li₂S—SiS₂—Li₃PO₄, Li₂S—SiS₂—LiₚMO_{q}, (p and q positive numbers, and M represents P, Si, Ge, B, Al, Ga or In), Li₇-xPS₆-xClₓ (0≤x≤2), Li₇-xPS₆-xBrₓ (0≤x≤2), Li₇-xPS₆-xIₓ (0≤x≤2), etc. These may be used alone or in a combination of two or more therefrom.

In non-limiting embodiments, the solid electrolyte may include an oxide-based amorphous solid electrolyte such as Li₂O—B₂O₃—P₂O₅, Li₂O—SiO₂, Li₂O—B₂O₃, Li₂O—B₂O₃—ZnO, etc.

As illustrated in FIG. 1, electrode tabs (a cathode tab and an anode tab) may protrude from the cathode current collector 105 and the anode current collector 125 included in each electrode cell to one side of the case 160. The electrode tabs may be welded together with the one side of the case 160 to be connected to an electrode lead (a cathode lead 107 and an anode lead 127) that may be extended or exposed to an outside of the case 160.

In FIG. 1, the cathode lead 107 and the anode lead 127 are illustrated as protruding from an upper side of the case 160 in a plan view, but the positions of the electrode leads are not limited thereto. For example, the electrode leads may protrude from at least one of two lateral sides of the case 160, and may also protrude from a lower side of the case 160. The cathode lead 107 and the anode lead 127 may be formed to protrude from different sides of the case 160.

The lithium secondary battery may be manufactured in, e.g., a cylindrical shape using a can, a prismatic shape, a pouch shape or a coin shape.

Hereinafter, experimental examples are proposed to more concretely describe the present disclosure. However, the following examples are only given for illustrating the present disclosure and those skilled in the related art will obviously understand that various alterations and modifications are possible within the scope and spirit of the present disclosure. Such alterations and modifications are duly included in the appended claims.

### EXAMPLES AND COMPARATIVE EXAMPLES

### (1) Preparation of Cathode Active Material

### Example 1

NiSO₄, CoSO₄ and MnSO₄ were added to a distilled water and mixed to satisfy a chemical formula of the lithium metal oxide particles shown in in Table 1. The distilled water was bubbled with N₂ for 24 hours to remove an internal dissolved oxygen before being used.

Thereafter, the mixed solution was added to a 60° C. reactor, NH₄OH was added to the reactor, and stirred at a constant speed to prepare a transition metal solution. NaOH was added to the reactor at a constant speed so that a molar ratio of the transition metal and NaOH in the transition metal solution was 1:2. Thereafter, a coprecipitation reaction was performed to prepare an active material precursor in the form of a hydroxide.

A precursor mixture was prepared by mixing lithium hydroxide as a lithium source and the active material precursor. Before preparing the precursor mixture, the active material precursor and lithium hydroxide were calcined at temperatures of 600° C. and 400° C., respectively, for 2 hours.

Thereafter, lithium hydroxide and the active material precursor were put into a dry high-speed mixer and uniformly mixed for about 5 minutes to prepare a mixture. The molar ratio of lithium hydroxide was adjusted so that a Li/Me ratio was controlled as shown in Table 1.

The mixture was put into a furnace and heated to a temperature of 970° C. or less at a ramping rate of 2° C./min, and maintained at 970° C. for a predetermined time. During the firing, oxygen was continuously passed through the furnace at a flow rate of 10 mL/min. After the firing, natural cooling was performed to room temperature, and lithium metal oxide particles in the form of secondary particles were prepared by pulverization and classification.

A temperature and a time of the firing were adjusted to prepare large-diameter particles having an average particle size (D50) of 10 μm and small-diameter particles having an average particle size (D50) of 3 μm. The large-diameter particles and the small-diameter particles were mixed in a weight ratio of 7:3 to prepare a cathode active material.

An average particle size of the lithium metal oxide particles was measured as a particle size at a 50% volume point in a volume particle size distribution of the cathode active material obtained using a laser diffraction method (microtrac, MT 3000).

A cathode slurry was prepared by mixing the lithium metal oxide particles as the cathode active material, carbon black as a conductive material, and polyvinylidene fluoride (PVDF) as a binder in a weight ratio of 92:5:3.

The cathode slurry was uniformly coated on a region of an aluminum foil (thickness: 15 μm) having a protrusion (a cathode tab) at one side thereof except for the protrusion, dried and pressed to prepare a cathode including a cathode active material layer that had a mixture density as shown in Table 1

A width, a length and a thickness of the cathode active material layer were measured to calculate a volume. A weight of the cathode active material layer was divided by the volume to obtain the mixture density. The weight of the cathode active material layer was calculated by subtracting a weight of the aluminum foil from a weight of the cathode.

A mixture of artificial graphite and natural graphite (weight ratio of 7:3) as an anode active material, styrene-butadiene rubber as a binder and carboxymethyl cellulose as a thickener were mixed in a weight ratio of 97:1:2 to prepare an anode slurry.

The anode slurry was uniformly coated on a region of a copper foil (thickness: 15 μm) having a protrusion (an anode tab) at one side thereof except for the protrusion, dried and pressed to prepare an anode.

A polyethylene separator (thickness: 20 μm) was interposed between the cathode and the anode to form an electrode assembly. A cathode lead and an anode lead were welded to each of the cathode tab and the anode tab.

The electrode assembly was placed in a pouch (case) so that portions of the cathode lead and the anode lead were exposed to an outside, and three sides except for an electrolyte injection side were sealed. After injecting an electrolyte solution, the electrolyte injection side was sealed. An impregnation was performed for 12 hours to obtain a secondary battery.

In a preparation of the electrolyte solution, a 1M LiPF₆ solution (EC/EMC/DEC mixed solvent with a volume ratio of 25:30:45) was prepared, and then 1 wt % of FEC (fluoroethylene carbonate), 0.3 wt % of VC (vinylene carbonate), 1.0 wt % of LiPO₂F₂ (lithium difluorophosphate), 0.5 wt % of PS (1,3-propane sultone), and 0.5 wt % of PRS (prop-1-ene-1,3-sultone) were added based on a total weight of the electrolyte solution.

### Other Examples and Comparative Examples

Cathode active materials and lithium secondary batteries were manufactured by the same method as that in Example 1, except that the particle size distribution of the cathode active material, the type of lithium source, the precursor calcination process, the Li/Me ratio and the mixture density were changed as shown in Table 1 below.

TABLE 1

| | | | | | Li/Me | mixture |
|---|---|---|---|---|---|---|
| | active material | particle diameter | lithium | precursor | molar | density |
| | chemical composition | distribution | source | calcination | ratio | (g/cc) |
| Example 1 | Li_{1.16}Ni_{0.27}Mn_{0.57}O₂ | large-diameter | lithium | ◯ | 1.38 | 2.8 |
| | | (10 μm) | hydroxide | | | |
| | | small-diameter | | | | |
| | | (3 μm) | | | | |
| Example 2 | Li_{1.16}Ni_{0.27}Mn_{0.57}O₂ | large-diameter | lithium | ◯ | 1.38 | 3.0 |
| | | (10 μm) | hydroxide | | | |
| | | small-diameter | | | | |
| | | (3 μm) | | | | |
| Example 3 | Li_{1.11}Ni_{0.35}Mn_{0.54}O₂ | large-diameter | lithium | ◯ | 1.25 | 2.8 |
| | | (12 μm) | hydroxide | | | |
| | | small-diameter | | | | |
| | | (3 μm) | | | | |
| Example 4 | Li_{1.11}Ni_{0.35}Mn_{0.54}O₂ | large-diameter | lithium | ◯ | 1.25 | 3.0 |
| | | (12 μm) | hydroxide | | | |
| | | small-diameter | | | | |
| | | (3 μm) | | | | |
| Example 5 | Li_{1.14}Ni_{0.30}Mn_{0.56}O₂ | 6 μm | lithium | ◯ | 1.31 | 2.8 |
| | | unimodal | carbonate | | | |
| Example 6 | Li_{1.14}Ni_{0.30}Mn_{0.56}O₂ | 6 μm | lithium | ◯ | 1.31 | 3.0 |
| | | unimodal | carbonate | | | |
| Example 7 | Li_{1.11}Ni_{0.35}Mn_{0.54}O₂ | large-diameter | lithium | ◯ | 1.25 | 3.2 |
| | | (12 μm) | hydroxide | | | |
| | | small-diameter | | | | |
| | | (3 μm) | | | | |
| Example 8 | Li_{1.16}Ni_{0.27}Co_{0.02}Mn_{0.55}O₂ | large-diameter | lithium | ◯ | 1.38 | 3.0 |
| | | (10 μm) | hydroxide | | | |
| | | small-diameter | | | | |
| | | (3 μm) | | | | |
| Comparative | Li_{1.16}Ni_{0.28}Mn_{0.56}O₂ | 6.5 μm | lithium | X | 1.39 | 2.8 |
| Example 1 | | unimodal | carbonate | | | |
| Comparative | Li_{1.16}Ni_{0.28}Mn_{0.56}O₂ | 6.5 μm | lithium | X | 1.39 | 3.0 |
| Example 2 | | unimodal | carbonate | | | |
| Comparative | Li_{1.16}Ni_{0.27}Co_{0.02}Mn_{0.55}O₂ | large-diameter | lithium | X | 1.39 | 3.0 |
| Example 3 | | (10 μm) | carbonate | | | |
| | | small-diameter | | | | |
| | | (3 μm) | | | | |
| Comparative | Li_{1.00}Ni_{0.75}Co_{0.02}Mn_{0.23}O₂ | 8.1 μm | lithium | X | 1.00 | 3.5 |
| Example 4 | | unimodal | hydroxide | | | |

### Experimental Example

### (1) Measurement of EIT and HIT

E_{IT} and H_{IT} of the lithium metal oxide particles (the large-diameter particles in the case of the bimodal distribution) of Examples and Comparative Examples were measured using a Vickers indenter (PICODENTOR HM500 manufactured by Helmut Fischer) under the conditions of a maximum indentation load of 7 mN, an indentation time of 70 seconds, and a creep time of 5 seconds.

The lithium metal oxide particles were pre-treated and placed in the Vickers indenter. Specifically, the lithium metal oxide particles were placed in a silicon mold. A curing solution containing an epoxy resin was placed in the silicon mold and cured at room temperature for 24 hours or more. After trimming an unmeasured portion of the cured sample, a particle cross-section was pre-treated using an ion miller.

Thereafter, E_{IT} and H_{IT} were measured on the cross-section of the pretreated sample using the Vickers indenter.

Specifically, particles within a range of ±0.5 μm from an average particle size (the large-diameter particle size in the case of large-diameter/small-diameter particle mixture, D50 in the case of the unimodal) shown in Table 1 were selected from the cross-section of the sample, E_{IT} and H_{IT} were measured, and then an arithmetic average was used as E_{IT} and H_{IT} of the corresponding cathode active material.

The obtained E_{IT} and H_{IT} were used to calculate E_{IT}/H_{IT}, and a CM value of each cathode active material of Examples and Comparative Examples was calculated using Equation 1.

The diameters of the lithium metal oxide particles included in a scanning electron microscope (SEM) image (magnification 1500 to 2500 times) showing a thickness*width cross-section of the cathode active material layer having a size of 70 μm*100 μm were measured, and a calculated average value was used as a D value of Equation 1.

### (2) Measurement of High-Temperature Capacity Retention

The lithium secondary batteries of Examples and Comparative Examples were subjected to 400 cycles of 0.5C charging and 0.5C discharging in a range of 2.5 V to 4.45 V at 45° C.

A high-temperature capacity retention was evaluated as a percentage of a discharge capacity at the 400th cycle relative to a discharge capacity at the 1st cycle.

The evaluation results are shown in Table 2 below.

TABLE 2

| | E_{IT} | H_{IT} | | | high temperature |
|---|---|---|---|---|---|
| | (GPa) | (GPa) | E_{IT}/H_{IT} | CM | capacity retention (%) |
| Example 1 | 41.686 | 2.31 | 18.0 | 94.8 | 82.2 |
| Example 2 | 51.492 | 1.977 | 26.0 | 136.8 | 83.5 |
| Example 3 | 56.773 | 3.66 | 15.5 | 119.1 | 82.0 |
| Example 4 | 63.977 | 2.774 | 23.1 | 177.1 | 83.1 |
| Example 5 | 31.211 | 1.52 | 20.5 | 71.8 | 80.3 |
| Example 6 | 54.121 | 2.48 | 21.8 | 76.3 | 81.7 |
| Example 7 | 67.642 | 2.32 | 29.2 | 224.3 | 78.5 |
| Example 8 | 52.648 | 1.995 | 26.4 | 138.6 | 83.7 |
| Comparative | 40.054 | 2.35 | 17.0 | 57.3 | 75.7 |
| Example 1 | | | | | |
| Comparative | 61.11 | 3.007 | 20.3 | 68.4 | 62.5 |
| Example 2 | | | | | |
| Comparative | 112.079 | 8.56 | 13.1 | 67.8 | 62.3 |
| Example 3 | | | | | |
| Comparative | 80.9 | 9.9 | 8.2 | 66.4 | 54.6 |
| Example 4 | | | | | |

Referring to Table 2, in Examples where the cathode active materials having the CM of 70 or more were used, increased high-temperature capacity retentions were achieved compared to those from Comparative Examples.

It is confirmed from Examples that even when using a Co-less, Mn-rich or Li-rich composition, sufficient capacity and high-temperature stability are implemented by adjusting the CM value considering both chemical and mechanical properties.

In Example 7 where CM exceeded 200, the internal density of the electrode increased to relatively degrade electrolyte impregnation properties. Accordingly, cell operation properties were relatively lowered.

What is claimed is:

1. A cathode for a lithium secondary battery, comprising:
a cathode current collector; and
a cathode active material layer on the cathode current collector, the cathode active material layer comprising lithium metal oxide particles that have CM defined by Equation 1 of 70 or more as a cathode active material:
$$CM = D * ( {E}_{IT} / {H}_{IT} ) / [ {( Li / Me )}_{2} ] \qquad [ Equation 1 ]$$
wherein, in Equation 1, D is an average particle diameter value calculated in micrometers after measuring diameters of particles with a diameter of 4 μm or more in the lithium metal oxide particles comprised in a scanning electron microscope (SEM) image showing a thickness*width cross-section of the cathode active material layer,
E_{IT} is a modulus value of the lithium metal oxide particles measured by a nano indentation method,
H_{IT} is a hardness value of the lithium metal oxide particles measured by a nano indentation method, and
Li/Me is a molar ratio of lithium to metals excluding lithium in the lithium metal oxide particles.

2. The cathode for a lithium secondary battery according to claim 1, wherein CM is in a range from 70 to 200.

3. The cathode for a lithium secondary battery according to claim 1, wherein E_{IT}/H_{IT} in Equation 1 is 15 or more.

4. The cathode for a lithium secondary battery according to claim 1, wherein E_{IT}/H_{IT} in Equation 1 is in a range from 15 to 50.

5. The cathode for a lithium secondary battery according to claim 1, wherein Li/Me in Equation 1 is 1.1 or more.

6. The cathode for a lithium secondary battery according to claim 1, wherein Li/Me in Equation is in a range from 1.1 to 1.6.

7. The cathode for a lithium secondary battery according to claim 1, wherein the lithium metal oxide particles comprise at least one of nickel and manganese, and a molar ratio of cobalt among metals excluding lithium in the lithium metal oxide particles is in a range from 0 to 0.1.

8. The cathode for a lithium secondary battery according to claim 1, wherein the lithium metal oxide particles comprise at least one of nickel and manganese, and a molar ratio of manganese among metals excluding lithium in the lithium metal oxide particles is in a range from 0.4 to 0.75.

9. The cathode for a lithium secondary battery according to claim 1, wherein the lithium metal oxide particles have a bi-modal distribution comprising large-diameter particles and small-diameter particles.

10. The cathode for a lithium secondary battery according to claim 9, wherein an average particle diameter of the large-diameter particles is in a range from 7 μm to 20 μm, and an average particle diameter of the small-diameter particles is in a range from 1 μm to 6 μm.

11. The cathode for a lithium secondary battery according to claim 9, wherein, E_{IT} and H_{IT} in Equation 1 represent a modulus and a hardness of the large-diameter particles, respectively.

12. The cathode for a lithium secondary battery according to claim 1, wherein E_{IT} in Equation 1 is in a range from 20 GPa to 100 GPa.

13. The cathode for a lithium secondary battery according to claim 1, wherein H_{IT} in Equation 1 is in a range from 1.0 GPa to 5 GPa.

14. The cathode for a lithium secondary battery according to claim 1, wherein an electrode density of the cathode active material layer is 2.8 g/cc or more.

15. A lithium secondary battery, comprising:
the cathode for a lithium secondary battery according to claim 1; and
an anode facing the cathode.
